(19) United States
(12) Patent Application Publication
(10) Pub. No.: US 2019/0271843 A1
(43) Pub. Date: Sep. 5, 2019

(54) TERMINAL APPARATUS, OPERATING METHOD, AND PROGRAM

(71) Applicant: SHARP KABUSHIKI KAISHA, Sakai City, Osaka (JP)

(72) Inventors: KATSUYA KATO, Sakai City (JP); YASUHIRO HAMAGUCHI, Sakai City (JP); HIROYUKI KATATA, Sakai City, Osaka (JP); KOKI SUZUKI, Sakai City (JP)

(21) Appl. No.: 16/344,291

(22) PCT Filed: Nov. 2, 2017
(86) PCT No.: PCT/JP2017/039664

§ 371 Date: Apr. 23, 2019

(30) Foreign Application Priority Data
Nov. 2, 2016 (JP) 2016-215411

(51) Int. Cl. G02B 27/01; G06K 9/00

(52) U.S. Cl. CPC G02B 27/017; G06K 9/00718; G02B 2027/0138; G06K 2009/00738; G02B 2027/0178; G06K 2209/23; G02B 2027/014

(57) ABSTRACT

A display unit is configured to display visual information that is visually recognized and superimposed on an external scene. A detection unit is configured to detect an event possibly causing danger by visually recognizing the visual information. A mounting unit is configured to be mountable on a head of a user and support the display unit and the detection unit. A controller is configured to suppress display of the visual information on the display unit in a case that the event is detected. Embodiments of the present invention can be applied to any of a terminal apparatus, a communication method, or a program.

### TECHNICAL FIELD

The present invention relates to a terminal apparatus, an operating method, and a program.

This application claims priority based on JP 2016-215411 filed on Nov. 2, 2016, the contents of which are incorporated herein by reference.

### BACKGROUND ART

As devices such as processors and sensors have become compact, the development of information terminal apparatuses that are mounted on human bodies and can easily be carried has been active. Such information terminal apparatuses are referred to as wearable terminals. Eyeglasses type terminal is a form of wearable terminal. An eyeglasses type terminal is provided with an eyeglasses type display and a mounting unit enabling the eyeglasses type terminal to be mounted on the head. Such a configuration mitigates physical burdens and psychological resistance related to the mounting.

The eyeglasses type terminal can present visual information such as videos and characters to individual users. Some eyeglasses type terminals can provide various functions through presentation of the visual information. For example, PTL 1 describes an image display system mounted on a user's head and torso. The image display system detects rotating actions of the head and the torso to determine the user's head shaking angle, and displays an image within the user's visual field to start image display based on a line of sight direction and the head shaking angle.

### CITATION LIST

### Patent Literature

PTL 1: Japanese Unexamined Patent Application Publication No. 2013-083731

### SUMMARY OF INVENTION

### Technical Problem

However, while the eyeglass type terminal is presenting visual information, the user has the user's attention attracted to the presented visual information and may fail to pay attention to surrounding environments. Furthermore, the presented visual information may block the surrounding environments. Thus, even in a case that an event occurs that may jeopardize the user's safety, the event may fail to be recognized or avoided.

In view of these circumstances, according to an aspect of the present invention, a terminal apparatus, an operating method, and a program are provided that are capable of improving safety for a user wearing the terminal apparatus.

### Solution to Problem

An aspect of the present invention is provided to accomplish the above-described object. According to the aspect of the present invention, a terminal apparatus is provided that includes a display unit configured to display visual information that is visually recognized and superimposed on an external scene, a detection unit configured to detect an event possibly causing danger by visually recognizing the visual information, a mounting unit configured to be mountable on a head of a user and support the display unit and the detection unit, and a controller configured to suppress display of the visual information on the display unit in a case that the event is detected.

### Advantageous Effects of Invention

According to an aspect of the present invention, safety for a user wearing the terminal apparatus can be improved.

### BRIEF DESCRIPTION OF DRAWINGS

FIG. 1 is a perspective view illustrating an example of an external configuration of a terminal apparatus according to a first embodiment.

FIG. 2 is a block diagram illustrating an example of a functional configuration of the terminal apparatus according to the first embodiment.

FIG. 3 is a flowchart illustrating an example of a process of suppressing presentation information according to the first embodiment.

FIG. 4 is a flowchart illustrating an example of a process of detecting a direction change according to the first embodiment.

FIG. 5 is a diagram illustrating a method for detecting a rotation angle in a horizontal plane according to the first embodiment.

FIG. 6 is a diagram illustrating an example of a rotation in the horizontal plane according to the first embodiment.

FIG. 7 is a flowchart illustrating an example of a process of detecting an up-down motion according to the first embodiment.

FIG. 8 is a flowchart illustrating another example of the process of detecting the up-down motion according to the first embodiment.

FIG. 9 is a flowchart illustrating an example of a process of detecting an object approach according to a second embodiment.

FIG. 10 is a flowchart illustrating another example of the process of detecting the object approach according to the second embodiment.

FIG. 11 is a flowchart illustrating an example process of detecting a serving area according to a third embodiment.

FIG. 12 is a block diagram illustrating an example of a functional configuration of a terminal apparatus according to a fourth embodiment.

FIG. 13 is a flowchart illustrating an example of a process of suppressing presentation information according to the fourth embodiment.

### DESCRIPTION OF EMBODIMENTS

### First Embodiment

Hereinafter, a first embodiment of the present invention will be described in detail with reference to the drawings.

First, an external configuration of a terminal apparatus 10 according to the present embodiment will be described.

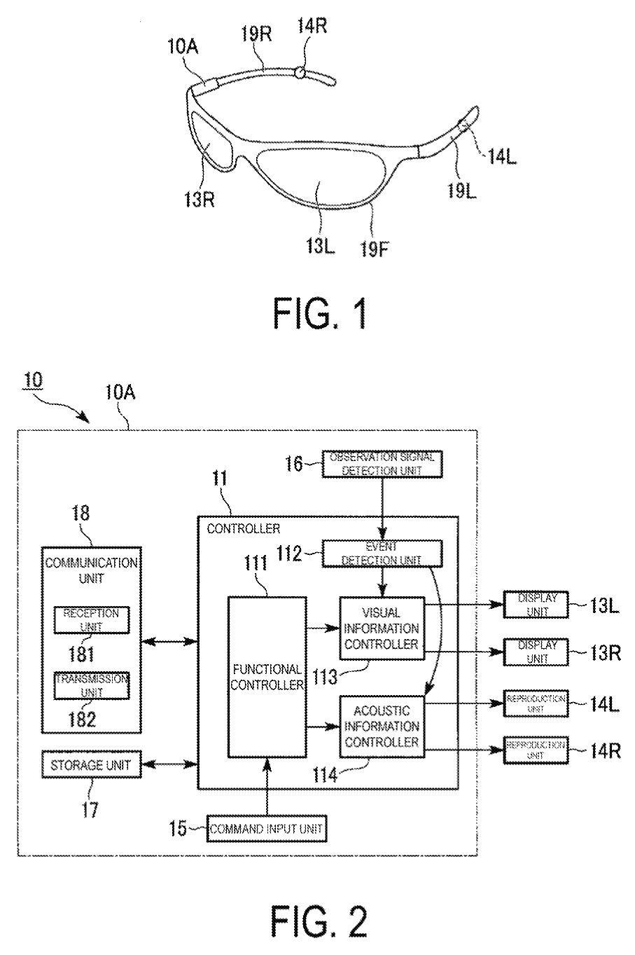

FIG. 1 is a perspective view illustrating an example of an external configuration of the terminal apparatus 10 according to the present embodiment. The terminal apparatus 10 is an eyeglasses type terminal that can be mounted on a head of a user.

The terminal apparatus 10 is configured to include a main body unit 10A, two display units 13L and 13R, two reproduction units 14L and 14R, two arms 19L and 19R, and one frame 19F.

The main body unit 10A performs processes for performing various functions of the terminal apparatus 10. An example of a functional configuration of the main body unit 10A will be described below.

Each of the display units 13L and 13R includes a display device on a surface of a member transmitting a visible light. The member transmitting the visible light is, for example, glass or polyethylene. The display devices each display visual information indicated by image signals input from the main body unit 10A. The display device is, for example, an organic Electro Luminescence (EL) display. Outer edges of the display units 13L and 13R are respectively supported by inner edges of two ring portions of the frame 19F. The display units 13L and 13R respectively present the visual information to the left eye and the right eye of the user wearing the terminal apparatus 10. The display units 13L and 13R function as a transmissive display that displays the visual information superimposed on an external scene caused by incident light from the outside world. In the description below, the visual information presented to the left eye and the visual information presented to the right eye may respectively be referred to as left visual information and right visual information. Note that the display device is not necessarily limited to an organic EL display but may be, for example, a liquid crystal display. Furthermore, a method for presenting the visual information by using the display device is not necessarily limited to a transmissive type but, for example, a retinal projection method may be used.

The reproduction units 14L and 14R are each configured to include a receiver for generating sound. The receivers each reproduces sound represented by audio signals input from the main body unit 10A to present acoustic information. The reproduction units 14L is mounted at a position closer to a second end of the arm 19L rather than a first end of the arm 19L, and the reproduction units 14R is mounted at a position closer to a second end of the arm 19R rather than a first end of the arm 19R. The reproduction units 14L and 14R are positioned near the left ear and the right ear of the user wearing the terminal apparatus 10 to present acoustic information at the corresponding positions.

In the description below, acoustic information presented to the left ear and acoustic information presented to the right ear may respectively be referred to as left acoustic information and right acoustic information.

The frame 19F has two ring portions of which respective outer edges are bonded together. Both ends of the frame 19F are respectively hinged to the first ends of the arms 19L and 19R.

The second ends of the arms 19L and 19R are each bent in the same direction. This shape allows each of the second ends of the arms 19L and 19R to be sandwiched between an auricle and the head of the user, with a central portion of the frame 19F supported at a nasal root of the user. The frame 19F and the arms 19L and 19R have such a configuration to enable the terminal apparatus 10 to be mounted on the user's head as a set of mounting units.

### Functional Configuration

Now, a functional configuration of the terminal apparatus 10 according to the present embodiment will be described below.

FIG. 2 is a block diagram illustrating an example of the functional configuration of the terminal apparatus 10 according to the present embodiment.

The terminal apparatus 10 is configured to include a controller 11, a command input unit 15, an observation signal detection unit 16, a storage unit 17, and a communication unit 18 that are provided in the main body unit 10A.

The controller 11 controls operation of the terminal apparatus 10. The controller 11 is configured to include a functional controller 111, an event detection unit 112, a visual information controller 113, and an acoustic information controller 114.

The functional controller 111 interprets a command indicated by a command input signal input from the command input unit 15. The command is an instruction, such as a start and termination of a function to be controlled and a change of operating manner, for controlling the functions of the terminal apparatus 10. Examples of the function of the terminal apparatus 10 include guidance of which items include trainings for various exercises and operations, reproduction of contents such as videos and music, and communication with a communication destination apparatus. In a case that the command interpreted indicates a start of a predetermined function, the functional controller 111 starts a process indicated by an instruction described in an application program corresponding to the command. Processes performed by the functional controller 111 include a process of acquiring various types of visual information and acoustic information. The visual information is information such as images, characters, symbols, and figures which can be visually perceived. The visual information may be any of, for example, information such as Augmented Reality (AR) display synthesized by the functional controller 111, information such as guidance display read from the storage unit 17, images captured by a camera (not illustrated), or receive information received from the communication destination apparatus by the communication unit 18. The acoustic information is information such as sound, music, and sound effects which can be aurally recognized. The acoustic information may be any of, for example, information such as guidance voice read from the storage unit 17, information synthesized by the functional controller 111, sound recorded by a microphone (not illustrated), and receive information such as sound, music, or sound effects received from the communication destination apparatus by the communication unit 18. These visual information and acoustic information are used for various applications such as trainings for various exercises or operations, entertainment such as games, viewing and listening of contents such as movies or music, information search, and communication with other people. In the present embodiment, the applications are not limited. The visual information includes the left visual information to be displayed on the display unit 13L and the right visual information to be displayed on the display unit 13R. One common piece of visual information may be used as the left visual information and the right visual information or different pieces of visual information may be used as the left visual information and the right visual information as in the case of stereo images. The acoustic information includes left acoustic information to be reproduced by the reproduction unit 14L and right acoustic information to be reproduced by the reproduction unit 14R. One piece of common acoustic information may be used as the left acoustic information and the right acoustic information or different pieces of acoustic information may be used as the left acoustic information and the right acoustic information as in the case of stereo sound. The functional controller 111 outputs the visual information and acoustic information acquired to the visual information controller 113 and the acoustic information controller 114, respectively.

The event detection unit 112 detects an event that may cause danger to the user by visually recognizing visual information displayed on the display units 13L and 13R, based on an observation signal input from the observation signal detection unit 16. The configuration of the observation signal detection unit 16 and type and aspect of the observation signal may differ depending on the type of an event to be detected. The event that may cause danger to the user includes both an event that has actually caused danger and an event that is likely to cause danger. The danger refers to jeopardizing safety and mainly to damaging the user's body. An event that may cause damage to the user may be hereinafter referred to as a predetermined event. Examples of the predetermined event includes an event in which the user acts irregularly. The irregular action typically refers to a momentum, in a predetermined rotating direction or a spatial direction, that is larger than a predetermined momentum. More specifically, the irregular action refers to a rapid change in the direction of the head of the user wearing the terminal apparatus 10. Such an event occurs in a case that the user hears an operating sound from a vehicle or any other object, and turns the head toward the direction of the sound. The object is not limited to an inanimate object but may be a living creature or a human being. The operating sound may be any of a sound such as an engine sound generated by activity of the object, a sound such as wind noise or frictional sound resulting from movement, a warning tone such as a horn or a buzzer, speech of a human being, and an animal call.

In a case of detecting a rapid change in the direction of the head, the event detection unit 112 uses, for example, an angular velocity signal and an acceleration signal input as observation signals. The event detection unit 112 identifies, as a vertical direction (z direction), a direction of a gravity acceleration component constantly detected from an acceleration in each direction in a three-dimensional space indicated by the acceleration signal. The event detection unit 112 calculates, from the angular velocity signal, an angular velocity component in a horizontal plane (x-y plane) in which the vertical direction serves as a rotation axis. The event detection unit 112 determines that the direction of the head has changed rapidly in a case that the angular velocity in the horizontal plane has an absolute value larger than a predetermined angular velocity threshold. The event detection unit 112 generates an event detection signal for indicating a rapid change in the direction of the head as a predetermined event, and outputs the resultant event detection signal to the visual information controller 113 and the acoustic information controller 114.

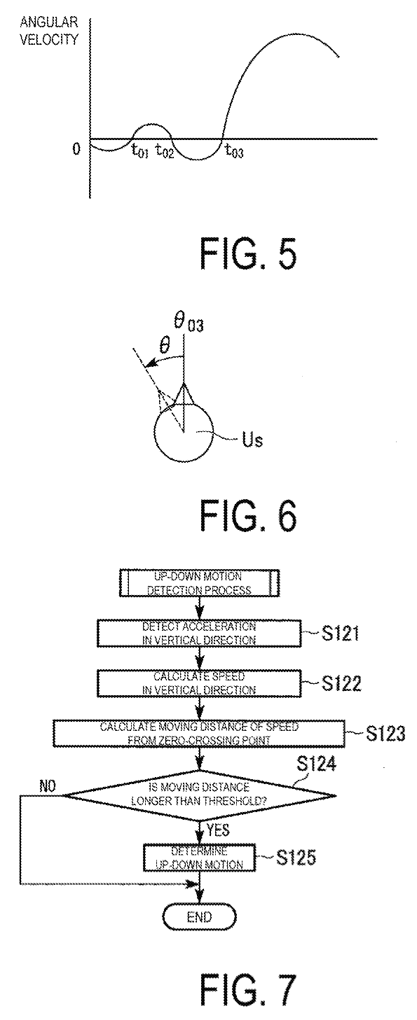

In a case of detecting a rapid change in the direction of the head, the event detection unit 112 may detect a zero crossing point of the angular velocity in the horizontal plane. The zero crossing point is a point of time when the value changes from positive to negative or negative to positive. In an example illustrated in FIG. 5, points of time t₀₁, t₀₂, and t₀₃ are each a zero crossing point. The event detection unit 112 time-integrates the angular velocity in the horizontal plane starting with a last detected zero crossing point to calculate an angle from the direction at the zero crossing point. In an example illustrated in FIG. 6, the event detection unit 112 time-integrates the angular velocity in the horizontal plane with reference to a direction θ₀₃ of the head of a user Us at a point of time t₀₃. to calculate an angle θ at the current point of time t. The event detection unit 112 determines that the direction of the head has changed rapidly in a case that the calculated angle is larger than a predetermined angle threshold. This allows a significant change, in the direction of the head, that is intended by the user to be discriminated from a slight change, in the direction of the head, that may constantly occur.

The visual information controller 113 receives visual information from the functional controller 111. In a case that an event occurrence signal is input from the event detection unit 112 to the visual information controller 113, the visual information controller 113 suppresses each of output of the left visual information to the display unit 13L and output of the right visual information to the display unit 13R. The suppression of the visual information may be either complete avoidance of output or a reduction in luminance gain below a predetermined luminance gain corresponding to a criteria. In the latter case, the visual information controller 113 generates a left image signal and a right image signal each indicating a luminance value for each pixel that is obtained by causing a reduced gain to act on luminance values representing the left visual information and the right visual information. The visual information controller 113 outputs the resultant left image signal and right image signal to the display units 13L and 13R, respectively.

On the other hand, in a case that no event detection signal is input from the event detection unit 112 to the visual information controller 113, the visual information controller 113 generates a left image signal and a right image signal each indicating a luminance value for each pixel that is obtained by causing a predetermined luminance gain to act on the luminance values representing the left visual information and the right visual information. The visual information controller 113 outputs the resultant left image signal and right image signal to the display units 13L and 13R, respectively.

The acoustic information controller 114 receives acoustic information from the functional controller 111. In a case that an event occurrence signal is input from the event detection unit 112 to the acoustic information controller 114, the acoustic information controller 114 suppresses each of output of the left acoustic information to the reproduction unit 14L and output of the right acoustic information to the reproduction unit 14R. The suppression of the acoustic information may be either complete avoidance of output or a reduction in volume gain below a predetermined volume gain corresponding to a criteria. In the latter case, the acoustic information controller 114 generates a left acoustic signal and a right acoustic signal each indicating an amplitude value for each sample that is obtained by causing a reduced gain to act on amplitude values representing the left acoustic information and the right acoustic information. The acoustic information controller 114 outputs the resultant left acoustic signal and right acoustic signal to the reproduction units 14L and 14R, respectively.

The command input unit 15 accepts a command indicated by the user to generate a command input signal for indicating the accepted command. The command input unit 15 is configured to include, for example, members such as buttons and volumes accepting the user's operations and a touch sensor for indicating positions on screens displayed on the display units 13L and 13R. The command input unit 15 may be configured to include a microphone (not illustrated) for recording a voice uttered by the user and a voice recognition unit (not illustrated) for performing a voice recognition process of voice signals of the recorded voice.

The observation signal detection unit 16 detects an observation signal used to detect the predetermined event. To detect a rapid change in the direction of the user, the observation signal detection unit 16 is configured to include a three-axis acceleration sensor and a three-axis angular velocity sensor. Sensitivity axes of the three acceleration sensors extend in directions orthogonal to directions in which rotation axes of the three angular velocity sensors extend.

The storage unit 17 stores various data used by the controller 11 to perform processes and various data acquired by the controller 11. The storage unit 17 is configured to include storage media such as a Random Access Memory (RAM) and a Read-Only Memory (ROM).

The communication unit 18 transmits and/or receives various data via a network to and/or from an apparatus separate from the terminal apparatus 10. The network establishes a connection with an apparatus (external apparatus) separate from the subject apparatus in conformity with, for example, IEEE 802.11 standards or Long Term Evolution-Advanced (LTE-A) standards. The communication unit 18 is configured to include a reception unit 181 and a transmission unit 182. The communication unit 18 is configured to include, for example, a radio communication interface.

The reception unit 181 receives, as a receive signal, a transmit wave carrying data transmitted from the external apparatus, demodulates the receive signal, and outputs the carried data to the functional controller 111 as receive data.

The transmission unit 182 modulates transmit data input from the functional controller 111 and transmits, to the external apparatus, a transmit signal resulting from the modulation.

### Suppression of Presentation Information

Now, a process of suppressing a presentation information according to the present embodiment will be described below.

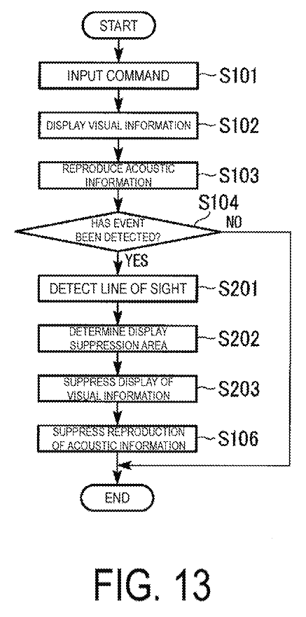

FIG. 13 is a flowchart illustrating an example process of suppressing the presentation information according to the present embodiment.

(Step S101) The functional controller 111 interprets a command indicated by a command input signal input from the command input unit 15. The functional controller 111 performs a process related to a function indicated by the command interpreted. The functional controller 111 outputs visual information and acoustic information generated during performance of the process to the visual information controller 113 and the acoustic information controller 114, respectively.

The process subsequently proceeds to a step S102.

(Step S102) The visual information controller 113 causes a predetermined luminance gain to act on the left visual information and the right visual information input from the functional controller 111, and outputs the resultant left visual information and right visual information to the display units 13L and 13R, respectively. The display units 13L and 13R respectively display the left visual information and the right visual information. The process subsequently proceeds to a step S103.

(Step S103) The acoustic information controller 114 causes a predetermined volume gain to act on left acoustic information and right acoustic information input from the functional controller 111, and outputs the resultant left acoustic information and right acoustic information to the reproduction units 14L and 14R, respectively. The reproduction units 14L and 14R respectively reproduce the left acoustic information and the right acoustic information. The process subsequently proceeds to a step S104.

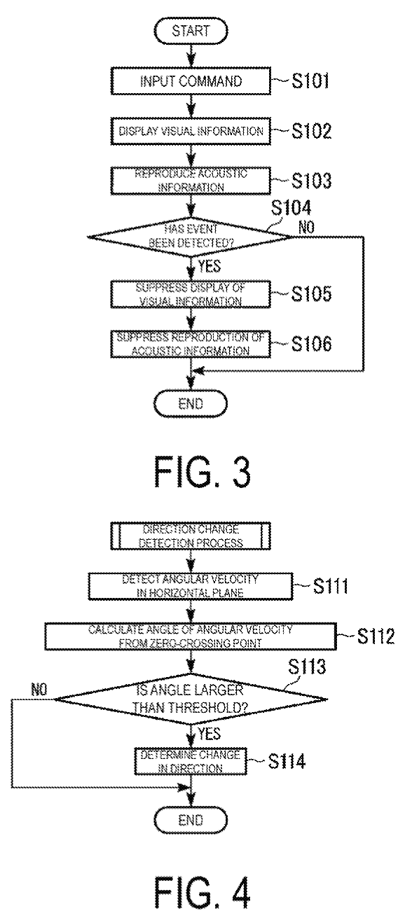

(Step S104) The event detection unit 112 determines whether the predetermined event has been detected or not, based on an observation signal input from the observation signal detection unit 16. In a case that it is determined that the prescribed event has been detected (YES in step S104), the process proceeds to a step S105. In a case that it is determined that the prescribed event has not been detected (NO in step S104), the process in FIG. 3 is terminated.

(Step S105) In a case that the event detection signal is input from the event detection unit 112 to the visual information controller 113, the visual information controller 113 suppresses each of the output of the left visual information to the display unit 13L and the output of the right visual information to the display unit 13R. The process subsequently proceeds to a step S106.

(Step S106) In a case that the event occurrence signal is input from the event detection unit 112 to the acoustic information controller 114, the acoustic information controller 114 suppresses each of the output of the left acoustic information to the reproduction unit 14L and the output of the right acoustic information to the reproduction unit 14R. The process in FIG. 3 is subsequently terminated.

### Direction Change Detection Process

Now, a process of detecting a direction change according to the present embodiment will be described below.

FIG. 4 is a flowchart illustrating an example process of detecting the direction change according to the present embodiment.

(Step S111) The event detection unit 112 detects the angular velocity in the horizontal plane from the angular velocity signal input from the observation signal detection unit 16. The process subsequently proceeds to a step S112.

(Step S112) The event detection unit 112 detects a zero crossing point from the detected angular velocity, and time-integrates the angular velocity to calculate the angle in the horizontal plane from the direction at the last detected zero crossing point. The process subsequently proceeds to a step S113.

(Step S113) The event detection unit 112 determines whether the calculated angle is larger than a predetermined angle or not. In a case that the calculated angle is determined to be larger than the predetermined angle (YES in step S113), the process proceeds to a step S114. In a case that the calculated angle is determined not to be larger than the predetermined angle (NO in step S113), the process illustrated in FIG. 4 is terminated.

(Step S114) The event detection unit 112 determines that a rapid change in the direction of the user's head has been detected as the predetermined event, and outputs, to each of the visual information controller 113 and the acoustic information controller 114, an event detection signal for indicating the detected rapid change in direction as detection of the predetermined event. The process illustrated in FIG. 4 is subsequently terminated.

In the above-described example, the event detection unit 112 detects a rapid change in the direction of the head as an event in which the user performs an irregular action, but the detection is not limited to this. The event detection unit 112 may detect a rapid change in the height of the head, in other words, an up-down motion of the head, instead of or in addition to the rapid change in the direction of the head. Such an event may occur in a case of climbing up or climbing down stairs or a change in posture. A change in posture may occur, for example, in a case of a change from an upright state to an inclined state or a squatting state or a return from the inclined state or the squatting state to the upright state.

In a case of detecting an up-down motion of the head, the event detection unit 112 subtracts the gravity acceleration from the acceleration in the vertical direction in the acceleration signal input from the observation signal detection unit 16 to calculate a motion acceleration. The motion acceleration is a substantial acceleration component resulting from a motion. The event detection unit 112 time-integrates the calculated motion acceleration to calculate the speed in the vertical direction.

The event detection unit 112 determines that an up-down motion of the head has occurred in a case that the calculated speed has an absolute value larger than a predetermined speed threshold. In a case of determining that an up-down motion of the head has occurred as the predetermined event, the event detection unit 112 outputs an event detection signal to each of the visual information controller 113 and the acoustic information controller 114.

### Up-Down Motion Detection Process

The event detection unit 112 may perform a process described below to detect an up-down motion as the predetermined event.

FIG. 7 is a flowchart illustrating an example process of detecting an up-down motion according to the present embodiment.

(Step S121) The event detection unit 112 subtracts the gravity acceleration from the acceleration in the vertical direction in the acceleration signal input from the observation signal detection unit 16 as an observation signal to calculate the motion acceleration in the vertical direction. The process subsequently proceeds to a step S122.

(Step S122) The event detection unit 112 time-integrates the calculated motion acceleration to calculate the speed in the vertical direction. The process subsequently proceeds to a step S123.

(Step S123) The event detection unit 112 detects a zero crossing point of the calculated speed. The event detection unit 112 time-integrates the calculated speed starting with the position at the last zero crossing point to calculate a moving distance from the zero crossing point. The process subsequently proceeds to a step S124.

(Step S124) The event detection unit 112 determines whether the calculated moving distance is longer than a predetermined moving distance threshold or not. In a case that the calculated moving distance is determined to be longer than the predetermined moving distance threshold (YES in step S124), the process proceeds to a step S125. In a case that the calculated moving distance is determined not to be longer than the predetermined moving distance threshold (NO in step S124), the process illustrated in FIG. 7 is terminated.

(Step S125) The event detection unit 112 determines that an up-down motion of the head has been detected as the predetermined event. The event detection unit 112 outputs, to each of the visual information controller 113 and the acoustic information controller 114, an event detection signal indicating the up-down motion of the head as the predetermined event. The process illustrated in FIG. 7 is subsequently terminated.

Note that, in the example illustrated in FIG. 7, the observation signal detection unit 16 for detecting an up-down motion of the head is configured to include a three-axis acceleration sensor but the configuration is not limited to this. The observation signal detection unit 16 may be configured to include an atmospheric pressure sensor (not illustrated) for detecting the atmospheric pressure at the current point of time. In that case, the observation signal detection unit 16 outputs, to the event detection unit 112, an atmospheric pressure signal for indicating the detected atmospheric pressure as an observation signal.

The event detection unit 112 may perform a process described below to detect an up-down motion as the predetermined event.

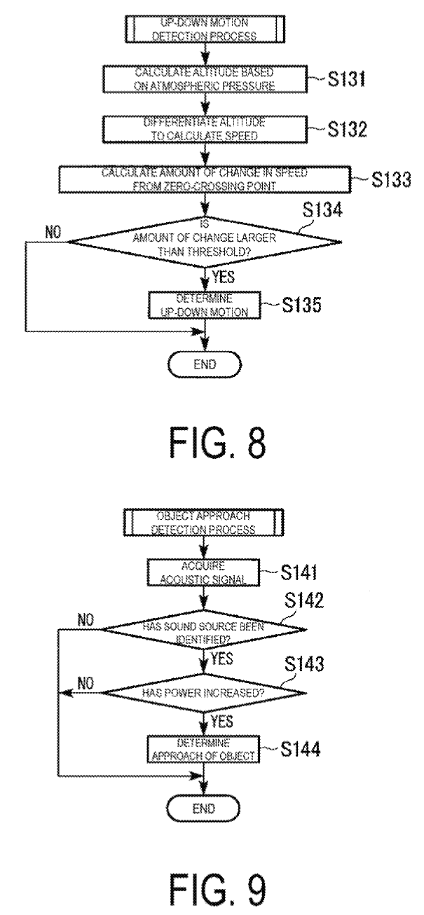

FIG. 8 is a flowchart illustrating another example process of detecting the up-down motion according to the present embodiment.

(Step S131) The event detection unit 112 calculates an altitude based on the atmospheric pressure indicated by the atmospheric pressure signal input from the observation signal detection unit 16. In a case of calculating the altitude, the event detection unit 112 uses, for example, a relationship indicated in Equation (1).

$$Equation ( 1 )$$

$$h = \frac{( {( \frac{{P}_{0}}{P} )}^{\frac{1}{5.257}} - 1 ) \cdot ( T + 273.15 )}{0.065} \qquad ( 1 )$$

In Equation (1), h denotes the altitude (unit: m). P₀ and P respectively denote a sea-level atmospheric pressure (unit: hPa) and a measured atmospheric pressure (unit: hPa). The measured atmospheric pressure is an atmospheric pressure measured by the atmospheric pressure sensor. T denotes temperature. The terminal apparatus 10 may be provided with a temperature sensor (not illustrated) in the main body unit 10A to measure the temperature. A preset predetermined value (for example, 1013.25 hPa) may be used as the sea-level atmospheric pressure. The process subsequently proceeds to a step S132.

(Step S132) The event detection unit 112 time-integrates the calculated altitude to calculate the speed in the vertical direction. The process subsequently proceeds to a step S133.

(Step S133) The event detection unit 112 detects a zero crossing point of the calculated speed. The event detection unit 112 calculates a difference between the altitude at the last zero crossing point and the altitude at the current point of time as a moving distance from the zero crossing point. The process subsequently proceeds to a step S134.

(Step S134) The event detection unit 112 determines whether the calculated moving distance is longer than a predetermined moving distance threshold or not. In a case that the calculated moving distance is determined to be longer than the predetermined moving distance threshold (YES in step S134), the process proceeds to a step S135. In a case that the calculated moving distance is determined not to be longer than the predetermined moving distance threshold (NO in step S134), the process illustrated in FIG. 7 is terminated.

(Step S135) The event detection unit 112 determines that an up-down motion of the head has been detected as the predetermined event. The event detection unit 112 outputs an event detection signal for indicating detection of the predetermined event to each of the visual information controller 113 and the acoustic information controller 114. The process illustrated in FIG. 8 is subsequently terminated.

Note that in the process illustrated in FIG. 8, a process in which the event detection unit 112 converts the atmospheric pressure into an altitude in a step S131 is included, but the process is not limited to this. In the process illustrated in FIG. 8, a process in which the event detection unit 112 converts the atmospheric pressure into an altitude may be omitted.

As described above, the terminal apparatus 10 according to the present embodiment is provided with the display units 13L and 13R capable of displaying visual information that is visually recognized and superimposed on the external scene. The terminal apparatus 10 is provided with the event detection unit 112 capable of detecting an event that may cause danger by visually recognizing the visual information. The terminal apparatus 10 is provided with the frame 19F and the arms 19L and 19R as a mounting unit capable of being mounted on the user's head to support the display units 13L and 13R and the event detection unit 112. The terminal apparatus 10 is provided with the visual-information controller 113 for suppressing display of the visual information on the display units 13L and 13R in a case that an event that may cause danger is detected.

With this configuration, in a case that an event is detected that may cause danger by visually recognizing the visual information, display of the visual information on the display units 13L and 13R is suppressed. Thus, the user wearing the terminal apparatus 10 can more appropriately recognize surrounding environments by visually recognizing the external scene. Accordingly, the user can more safely utilize the terminal apparatus 10.

Furthermore, the event detection unit 112 can detect the moving distance of the event detection unit 112 being longer than a predetermined moving distance threshold, as an event that may cause danger by visually recognizing the visible information.

With this configuration, display of the visual information on the display units 13L and 13R is suppressed in a case that the head of the user wearing the terminal apparatus 10 moves a long distance. Thus, in a case of performing an irregular action to move a long distance, the user can more appropriately recognize the surrounding environments by visually recognizing the external scene.

Furthermore, the event detection unit 112 can detect the amount of change in a predetermined rotating direction as the moving distance of the event detection unit 112.

With this configuration, in a case that the direction of the head of the user wearing the terminal apparatus 10 changes rapidly, display of the visual information on the display units 13L and 13R is suppressed. Thus, in a case of intentionally changing the direction of the head, the user can more appropriately recognize the surrounding environments by visually recognizing the external scene.

Furthermore, the event detection unit 112 can detect the moving distance in the vertical direction as the moving distance of the event detection unit 112.

With this configuration, in a case that the height of the head of the user wearing the terminal apparatus 10 changes rapidly, display of the visual information on the display units 13L and 13R is suppressed. Thus, in a case that the height of the user's head changes, for example, in a case that the user's posture changes during climbing-up or climbing-down of stairs or the like, the user can more appropriately recognize the surrounding environments by visually recognizing the external scene.

Furthermore, the terminal apparatus 10 is provided with the reproduction units 14L and 14R capable of reproducing the audible acoustic information. In a case that an event is detected that may cause danger by visually recognizing the visual information, the terminal apparatus 10 suppresses reproduction of the acoustic information in the reproduction units 14L and 14R.

With this configuration, in a case that an event is detected that may cause danger by visually recognizing the visual information, reproduction of the acoustic information in the reproduction unit 14L and 14R is suppressed. Thus, by listening to surrounding sound, the user wearing the terminal apparatus 10 can more appropriately recognize the surrounding environments in a situation where the user fails to rely thoroughly on the visual sense, for example, where the surrounding environments are out of sight of the user.

### Second Embodiment

Now, a second embodiment of the present invention will be described below. The same components as the corresponding components of the first embodiment are denoted by the same reference signs, and duplicate descriptions are omitted. Differences from the first embodiment will be focused on.

In the present embodiment, the event detection unit 112 detects approach of an object as the predetermined event based on an observation signal input from the observation signal detection unit 16.

The observation signal detection unit 16 is configured to include a sound collection unit (microphone) for recording an incoming sound. The sound collection unit generates an acoustic signal for indicating a recorded sound and outputs the resultant acoustic signal to the event detection unit 112 as an observation signal.

The event detection unit 112 calculates an acoustic feature amount and power (volume) for each frame (for example, 10 ms to 50 ms) from the acoustic signal input from the observation signal detection unit 16. The acoustic feature amount is, for example, a set of a mel-frequency cepstrum and a fundamental frequency. The storage unit 17 prestores sound source data. The sound source data is configured to include a time sequence of acoustic feature amounts within a predetermined period of time (for example, 100 ms to 1 s) for each sound source. The sound source may be, for example, an operating sound of a vehicle such as a passenger car, a truck, or a bicycle, in other words, a traveling sound resulting from traveling, or a warning tone generated in accordance with an instruction from a driver.

The event detection unit 112 calculates, for each sound source, an index value of similarity between a time sequence of acoustic feature amounts comprising calculated acoustic feature amounts and a time sequence of acoustic feature amounts indicated by sound source data. The similarity is, for example, a Euclidean distance. The Euclidean distance is an index value for indicating the magnitude of a difference between two acoustic feature amounts that are vector quantities. The Euclidean distance is an index value that indicates a lower similarity in a case that an Euclidean distance is a larger value, and indicates a higher similarity in a case that an Euclidean distance is a smaller value. The event detection unit 112 determines whether a similarity related to a sound source with the highest calculated similarity is higher than a predetermined similarity or not. In a case of determining that the similarity is higher than the predetermined similarity, the event detection unit 112 identifies the corresponding sound source (sound source identification). In a case that calculated power increases over time, the event detection unit 112 determines that approach of an object corresponding to the sound source has been detected. For example, in a case that the sound source is a traveling sound of a vehicle, the event detection unit 112 determines approach of the vehicle. The event detection unit 112 outputs, to each of the visual information controller 113 and the acoustic information controller 114, an event detection signal for indicating approach of the object as the predetermined event. On the other hand, in a case of determining that the similarity related to the sound source with the highest calculated similarity is lower than or equal to the predetermined similarity, the event detection unit 112 determines that the sound source cannot be identified. Even in a case that the sound source can be identified, the event detection unit 112 determines that approach of the object has not been detected in a case that the power remains unchanged or deceases over time.

Now, a process of detecting object approach according to the present embodiment will be described below.

FIG. 9 is a flowchart illustrating an example process of detecting the object approach according to the third embodiment.

(Step S141) The event detection unit 112 acquires an acoustic signal from the observation signal detection unit 16 to calculate, for the acoustic signal acquired, the power and the acoustic feature amount for each frame. The process subsequently proceeds to a step S142.

(Step S142) The event detection unit 112 calculates a similarity between a time sequence of calculated acoustic feature amounts and a time sequence of acoustic feature amounts for each sound source, to determine whether the similarity related to the sound source with the highest calculated similarity is higher than the predetermined similarity or not. In a case of determining that the similarity is higher than a predetermined threshold, the event detection unit 112 identifies the corresponding sound source (YES in step S142). The process proceeds to a step S143. In a case of determining that the similarity is lower than or equal to the predetermined threshold, the event detection unit 112 determines that the sound source cannot be identified (NO in step S142). The process illustrated in FIG. 9 is terminated.

(Step S143) The event detection unit 112 determines whether the power increases over time or not. In a case that the event detection unit 112 determines that the power increases over time (YES in step S143), the process proceeds to a step S144. In a case that the event detection unit 112 determines that the power does not increase over time (NO in step S143), the process illustrated in FIG. 9 is terminated.

(Step S144) The event detection unit 112 determines approach of an object related to the identified sound source. The event detection unit 112 outputs, to each of the visual information controller 113 and the acoustic information controller 114, an event detection signal for indicating approach of the object as the predetermined event. The process illustrated in FIG. 9 is subsequently terminated.

In the example illustrated in FIG. 9, detection of the object approaching the terminal apparatus 10 is illustrated as the predetermined event. However, the event detection unit 112 may detect approach to a static object or a slowly moving object in conjunction with movement of the terminal apparatus 10. Such an object is, for example, an obstacle placed on a passageway.

Thus, the observation signal detection unit 16 and the event detection unit 112 may be configured as, for example, an object detection sensor. The terminal apparatus 10 is provided with a signal transmission unit (not illustrated) on the frame 19F. The signal transmission unit is installed at a position and in an orientation where the signal transmission unit can transmit a signal within a predetermined viewing angle (for example, 30° to 45°) around the front of the user with the terminal apparatus 10 mounted on the user. For example, infrared rays or ultrasonic waves can be used as the transmission signal.

The observation signal detection unit 16 receives, as an observation signal, a signal having a component with a wavelength common to the signal transmitted by the signal transmission unit. The observation signal detection unit 16 outputs the received observation signal to the event detection unit 112.

The event detection unit 112 detects a signal level of the observation signal input from the observation signal detection unit 16. In a case that a level difference between the signal level of the detected observation signal and the signal level of the transmission signal is smaller than a predetermined level difference threshold, the event detection unit 112 determines that an object has been detected within a predetermined range from the event detection unit 112. The event detection unit 112 may detect a propagation time from the transmission of the delivery signal until the arrival of the observation signal. The event detection unit 112 may detect a phase difference as a physical amount for indicating the propagation time. In a case that the detected propagation time is shorter than a predetermined propagation time, the event detection unit 112 determines that an object has been detected within a predetermined range from the event detection unit 112. The predetermined range is a range located within the viewing angle of the signal transmission unit and in which a distance from the observation signal detection unit 16 is shorter than a predetermined distance. The event detection unit 112 outputs, to each of the visual information controller 113 and the acoustic information controller 114, an event detection signal for indicating approach to the object as the predetermined event.

Now, another example process of detecting the object approach according to the present embodiment will be described below.

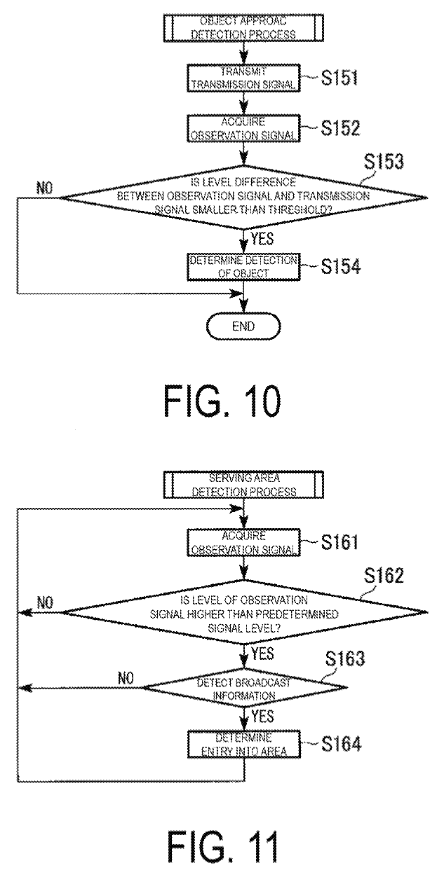

FIG. 10 is a flowchart illustrating the another example process of detecting the object approach according to the present embodiment.

(Step S151) The signal transmission unit transmits the transmission signal within the predetermined viewing angle. The process subsequently proceeds to a step S152.

(Step S152) The event detection unit 112 acquires an observation signal from the observation signal detection unit 16. The process subsequently proceeds to a step S153.

(Step S153) The event detection unit 112 detects the signal level of the observation signal to determine whether the level difference between the signal level of the observation signal and the signal level of the transmission signal is smaller than the predetermined level difference threshold.

In a case that the event detection unit 112 determines that the level difference is smaller than the predetermined level difference threshold (YES in step S153), the process proceeds to a step S154.

In a case that the event detection unit 112 determines that the level difference is not smaller than the predetermined level difference threshold (NO in step S153), the process illustrated in FIG. 10 is terminated.

(Step S154) The event detection unit 112 determines that an object has been detected within a predetermined range from the event detection unit 112, and outputs, to each of the visual information controller 113 and the acoustic information controller 114, an event detection signal for indicating approach to the object as the predetermined event. The process illustrated in FIG. 10 is subsequently terminated.

As described above, the event detection unit 112 in the terminal apparatus 10 according to the present embodiment detects approach of the object as an event that may cause danger by visually recognizing the visible information.

With this configuration, in a case that the approach of the object is detected, display of the visual information on the display units 13L and 13R is suppressed. Then, the user can visually recognize the external scene to confirm the approach of the object. Accordingly, the user can safely utilize the terminal apparatus 10.

The event detection unit 112 determines the type of the sound source by using the acoustic signal acquired, and in a case that the determined type of the sound source is an operating sound of a vehicle, detects approach of the vehicle based on the signal level of the acoustic signal.

With this configuration, in a case that the approach of the vehicle is detected, display of the visual information on the display units 13L and 13R is suppressed. Then, the user can visually recognize the external scene to confirm the approach of the vehicle, avoiding contact with the vehicle.

Furthermore, the terminal apparatus 10 is provided with a signal transmission unit for transmitting a transmission signal. The event detection unit 112 detects an object based on the level difference between the received observation signal and the transmission signal or the propagation time from the transmission to the reception.

With this configuration, in a case that the user wearing the terminal apparatus 10 detects an approaching object, display of the visual information on the display units 13L and 13R is suppressed. Then, the user can visually recognize the external scene to confirm the approaching object, avoiding contact with the object.

### Third Embodiment

Now, a third embodiment of the present invention will be described below. The same components as the corresponding components of the above-described embodiments are denoted by the same reference signs, and duplicate descriptions are omitted. Differences from the above-described embodiments will be focused on.

In the present embodiment, the event detection unit 112 detects an entry into a predetermined area as the predetermined event based on an observation signal input from the observation signal detection unit 16.

Here, the area refers to an area where, in a case of visually recognizing the visual information displayed on the display units 13L and 13R, the user wearing the terminal apparatus 10 may be subjected to danger. Such an area is, for example, a space with a step, a slope, or a recess and protrusion, a little space, a space around which various objects are installed, or a driver's seat in a vehicle.

The observation signal detection unit 16 is configured to include, for example, a receiver receiving a radio wave in a predetermined frequency band. The observation signal detection unit 16 outputs the received receive signal to the event detection unit 112 as an observation signal. The receiver may be the reception unit 181 of the communication unit 18.

The event detection unit 112 determines whether the signal level of the observation signal input from the observation signal detection unit 16 is higher than a predetermined signal level or not. In a case that signal level of the observation signal is higher than the signal level of the process, the event detection unit 112 demodulates the observation signal to attempt detection of carried broadcast information. The broadcast information is information used by a base station apparatus to broadcast a radio network which the base station apparatus is constituting. The broadcast information is, for example, a Service Set IDentifier (SSID) transmitted from the base station apparatus by using a beacon defined in IEEE 802.15. In a case of detecting the broadcast information, the event detection unit 112 determines entry of the terminal apparatus 10 into an area (coverage), corresponding to the predetermined area, in which the base station apparatus can communicate with the terminal apparatus 10. The event detection unit 112 outputs, to each of the visual information controller 113 and the acoustic information controller 114, an event detection signal for indicating the entry into the predetermined area as the predetermined event. In a case of detecting no broadcast information, the event detection unit 112 determines that the terminal apparatus 10 has not entered the predetermined area.

Now, an example process of detecting a serving area according to the present embodiment will be described below.

FIG. 11 is a flowchart illustrating the example process of detecting the serving area according to the present embodiment.

(Step S161) The event detection unit 112 acquires an observation signal from the observation signal detection unit 16. The process subsequently proceeds to a step S162.

(Step S162) The event detection unit 112 detects the signal level of the observation signal to determine whether the detected signal level is higher than a predetermined signal level threshold. In a case that the event detection unit 112 determines that the detected signal level is higher than the predetermined signal level threshold (YES in step S162), the process proceeds to a step S163. In a case that the event detection unit 112 determines that the detected signal level is not higher than the predetermined signal level threshold (NO in step S162), the process illustrated in FIG. 11 is terminated.

(Step S163) The event detection unit 112 attempts to detect broadcast information carried in the observation signal, and in a case that broadcast information is detected (YES in step S163), the process proceeds to a step S164. In a case that no broadcast information is detected (NO in step S163), the process illustrated in FIG. 11 is terminated.

(Step S164) The event detection unit 112 determines that the terminal apparatus 10 has entered the predetermined area. The event detection unit 112 outputs, to each of the visual information controller 113 and the acoustic information controller 114, an event detection signal for indicating the entry into the predetermined area as the predetermined event. The process illustrated in FIG. 11 is subsequently terminated.

Note that, in the above-described example, in a case that the signal level of the carrier transmitted from the base station apparatus is higher than or equal to the predetermined signal level and the broadcast information is successfully detected, the event detection unit 112 determines that terminal apparatus 10 has entered the predetermined area. However, the present invention is not limited to this. Carrying and detection of the broadcast information may be omitted. Furthermore, in the above-described example, the event detection unit 112 uses the signal level of radio waves in a case of determining whether the terminal apparatus 10 has entered the predetermined area. However, the present invention is not limited to this. For example, instead of radio waves, infrared rays, visible light, ultrasonic waves, or the like may be used.

As described above, the event detection unit 112 in the terminal apparatus 10 according to the present embodiment detects an entry into an predetermined area as an event that may cause danger by visually recognizing the visual information.

With this configuration, in a case that the user wearing the terminal apparatus 10 enters the predetermined area, display of the visual information on the display units 13L and 13R is suppressed. In a case that, for example, the following is set as the predetermined area: a space with a step, a slope, or a recess and protrusion, a little space, a space around which various objects are installed, or a driver's seat in a vehicle, the user can recognize, in those areas, the surrounding environments by visually recognizing the external scene. Accordingly, the user can safely utilize the terminal apparatus 10.

### Fourth Embodiment

Now, a fourth embodiment of the present invention will be described below. The same components as the corresponding components of the above-described embodiments are denoted by the same reference signs, and duplicate descriptions are omitted. Differences from the above-described embodiments will be focused on.

The event detection unit 112 according to the present embodiment further detects a line of sight direction of each of the left and right eyes of the user wearing the terminal apparatus 10. The visual information controller 113 suppresses visual information, included in the visual information acquired from the functional controller 111, that is presented within a predetermined range from the line of sight direction.

### Functional Configuration

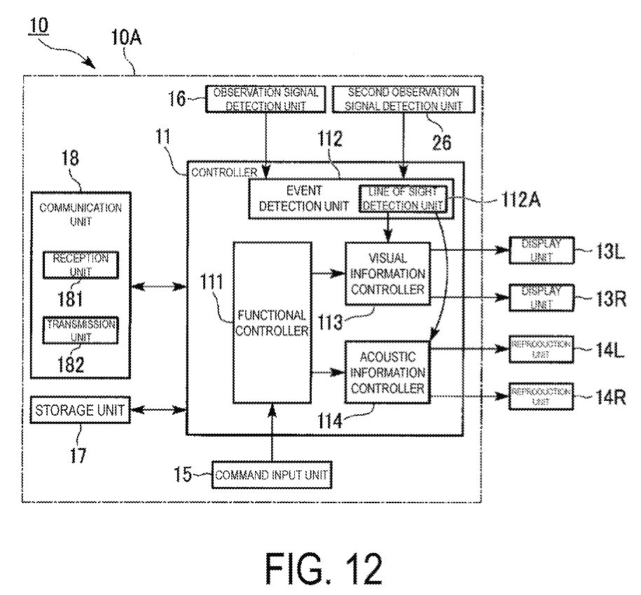

FIG. 12 is a block diagram illustrating an example of a functional configuration of the terminal apparatus 10 according to the present embodiment.

The terminal apparatus 10 is configured to further include a second observation signal detection unit 26.

The second observation signal detection unit 26 detects a second observation signal, and outputs the detected observation signal to the event detection unit 112. The second observation signal is used by a line of sight detection unit 112A (described below) to detect the line of sight direction of the user wearing the terminal apparatus 10. The type of the second observation signal relies on a detection method for the line of sight direction.

The event detection unit 112 is configured to further include the line of sight detection unit 112A. The line of sight detection unit 112A detects the line of sight direction of the user based on second observation signal input from the observation signal detection unit 26. The line of sight detection unit 112A may receive, for example, image signals for indicating the left and right eyes of the user, as second observation signals. The second observation signal detection unit 26 is configured to include an image capturing unit (not illustrated) for capturing images of the left and right eyes of the user. The image capturing unit is disposed at a position and in an orientation where the areas of the left and right eyes of the user are included in the visual field of the image capturing unit, with the terminal apparatus 10 mounted on the user. The line of sight detection unit 112A uses a well-known image recognition technique to detect the positions of the inner corner and the iris of the eye in an image of each of the left and right eyes indicated by the image signals. Based on the detected positional relationship between the inner corner and the iris of the eye, the line of sight detection unit 112A uses a well-known line of sight detection technique to calculate the line of sight direction of each of the left and right eyes. The line of sight detection unit 112A outputs, to the visual information acquisition unit 113, line of sight signals for indicating the calculated line of sight directions.

Note that the line of sight detection unit 112A may receive, as second observation signals, myoelectric potential signals for indicating myoelectric potentials of peripheries of the left and right eyes of the user. The line of sight detection unit 112A detects the line of sight directions of the left and right eyes of the user from the myoelectric potential signals acquired by using an Electro-Oculo-Graph method for the myoelectric potential signals. In that case, the line of sight detection unit 112A is configured to include, as the second observation signal detection unit 26, electrode plates comprising conductors for detecting the myoelectric signals. The electrode plates are disposed, in the frame 19F at positions and in orientations where the electrode plates are in contact with peripheries of the left and right eyes of the user with the terminal apparatus 10 mounted on the user.

The visual information controller 113 receives visual information from the line of sight detection unit 112A. The visual information controller 113 sets, as display suppression areas, areas included in the display areas of the display units 13L and 13R and located within predetermined ranges from the line of sight directions indicated by the line of sight signals. More specifically, the visual information controller 113 determines an intersection point between each of the display areas of the display units 13L and 13R and a straight line extending from the central fovea of the corresponding eye of the user wearing the terminal apparatus 10 in the line of sight direction of the eye, and determines, as a display suppression area, an area within a predetermined range (for example, 3° to 10°) from the intersection point. The central fovea is a region at which light arriving through the pupil concentrates. For each of the left visual information and the right visual information, the visual information controller 113 suppresses the visual information in each of the left and right display suppression areas, and does not suppress the visual information in the other portions. In a case of suppressing the visual information in the display suppression areas, the visual information controller 113 may set the luminance gain acting on the luminance value to be lower than the predetermined gain or set the luminance gain to zero. In a case of suppressing the visual information in the display suppression areas, the visual information controller 113 may move the visual information included in the left and right visual information acquired and located in the display suppression areas, to outside of the display suppression areas. The visual information controller 113 outputs, to the display units 13L and 13R respectively, image signals for indicating the left and right visual information obtained by suppressing the visual information in the display suppression areas.

### Suppression of Presentation Information

Now, a process of suppressing a presentation information according to the present embodiment will be described below.

FIG. 13 is a flowchart illustrating an example of a process of suppressing the presentation information according to the present embodiment.

The process illustrated in FIG. 13 has steps S101 to S104, S106, and S201 to S203. The steps S101 to S104 and S106 are respectively similar in processing to the steps S101 to S104 and S106 in FIG. 3, and thus, duplicate descriptions are omitted.

In the present embodiment, in a case that the event detection unit 112 determines that the predetermined event has been detected, based on an observation signal input from the observation signal detection unit 16 (YES in step S104), the process proceeds to step S201.

(Step S201) The line of sight detection unit 112A detects the line of sight direction of each eye of the user wearing the terminal apparatus 10 based on a second observation signal input from the second observation signal detection unit 26. The line of sight detection unit 112A outputs, to the visual information acquisition unit 113, line of sight signals for indicating the detected line of sight directions. The process subsequently proceeds to a step S202.

(Step S202) The visual information controller 113 determines, as display suppression areas, areas included in the display areas and located within predetermined ranges from the line of sight directions. The process subsequently proceeds to a step S203.

(Step S203) For each of the left visual information and the right visual information, the visual information controller 113 suppresses output of the visual information to the display units 13L and 13R in each of the left and right display suppression areas. The process subsequently proceeds to the step S106.

As described above, in the terminal apparatus 10 according to the present embodiment, the event detection unit 112 detects the line of sight directions of the user wearing the terminal apparatus 10. The visual information controller 113 suppresses display of the visual information in the display suppression areas within the predetermined ranges from the line of sight directions.

According to this configuration, the display of the visual information is suppressed in the display suppression areas, included in the display areas for the visual information, that includes areas being gazed by the user, and the display of the visual information is maintained in the display areas other than the display suppression areas. Thus, by viewing the external scene through the display suppression areas, the user can more appropriately recognize the surrounding environments and visually recognize the visual information in areas not being gazed. This enables a reduction in lack of the visual information presented to the user and also allows the terminal apparatus 10 to be safely utilized.

The embodiments of the present invention have been described in detail above referring to the drawings, but the specific configuration is not limited to the above embodiments and various amendments can be made to a design that fall within the scope that does not depart from the gist of the present invention.

For example, the event detection unit 112 may detect one or more of the illustrated predetermined events described in the first to third embodiments and may not detect the other predetermined events. Here, it is needed that the observation signal detection unit 16 can detect observation signals used to detect the respective events.

Furthermore, a partial configuration of the terminal apparatus 10 may be omitted. For example, the reproduction units 14L and 14R and the acoustic information controller 114 may be omitted. The communication unit 18 may be omitted. The command input unit 15 may be separate from the terminal apparatus 10 in a case that the command input unit 15 can transmit and/or receive various signals to and/or from the controller 11.

Note that the aspect of the present embodiment can be implemented in the following aspects.

(1) A terminal apparatus including a display unit configured to display visual information that is visually recognized and superimposed on an external scene, a detection unit configured to detect an event possibly causing danger by visually recognizing the visual information, a mounting unit configured to be mountable on a head of a user and support the display unit and the detection unit, and a controller configured to suppress display of the visual information on the display unit in a case that the event is detected.

(2) The terminal apparatus in (1), in which the detection unit is capable of detecting, as the event, that a moving distance of the detection unit is longer than a predetermined moving distance threshold.

(3) The terminal apparatus in (2), in which the detection unit is capable of detecting an amount of change in a rotating direction as the moving distance of the detection unit.

(4) The terminal apparatus in (2) or (3), in which the detection unit is capable of detecting the moving distance in a vertical direction as the moving distance of the detection unit.

(5) The terminal apparatus in any of (1) to (4), in which the detection unit detects approach of an object as the event.

(6) The terminal apparatus in (5), in which the detection unit determines a type of a sound source by using an acoustic signal acquired, and in a case that the type of the sound source determined is a traveling sound of a vehicle, detects the approach of the object based on a signal level of the acoustic signal.

(7) The terminal apparatus in (5) or (6), in which the terminal apparatus includes a signal transmission unit configured to transmit a transmission signal and the detection unit detects approach of the object based on a level difference between a receive signal and the transmission signal or a time difference from transmission of the delivery signal to reception of the receive signal.

(8) The terminal apparatus in (1) to (7), in which the detection unit detects an entry into a predetermined area as the event.

(9) The terminal apparatus in any one of (1) to (8), in which the detection unit detects a line of sight direction of the user, and the controller suppresses display of the visual information within a predetermined range from the line of sight direction.

(10) The terminal apparatus in any one of (1) to (9), in which the terminal apparatus includes a reproduction unit configured to reproduce acoustic information that is audible, and the controller suppresses reproduction of the acoustic information in the reproduction unit in a case that the event is detected.

(11) An operating method for a terminal apparatus including a display unit configured to display visual information that is visually recognized and superimposed on an external scene, a detection unit configured to detect an event possibly causing danger by visually recognizing the visual information, and a mounting unit configured to be mountable on a head of a user and support the display unit and the detection unit, the operating method including the step of suppressing display of the visual information on the display unit in a case that the event is detected.

(12) A program for a computer of a terminal apparatus including a display unit configured to display visual information that is visually recognized and superimposed on an external scene, a detection unit configured to detect an event possibly causing danger by visually recognizing the visual information, and a mounting unit configured to be mountable on a head of a user and support the display unit and the detection unit, the program causing the computer to perform suppressing display of the visual information on the display unit in a case that the event is detected.

A part of the terminal apparatus 10, for example, the functional controller 111, the event detection unit 112, the visual information controller 113, and the acoustic information controller 114 may be realized by a computer. In that case, this configuration may be realized by recording a program for realizing such control functions on a computer-readable recording medium and causing a computer system to read the program recorded on the recording medium for execution.

Additionally, the terminal apparatus 10 in the above-described embodiments may be partially or completely realized as an integrated circuit such as a Large Scale Integration (LSI) circuit. The functional blocks of a part of the terminal apparatus 10 may be individually realized as processors or may be partially or completely integrated into a processor. The circuit integration technique is not limited to LSI but may be realized as dedicated circuits or a multi-purpose processor. Furthermore, in a case that advances in semiconductor technology lead to the advent of a circuit integration technology that replaces an LSI, an integrated circuit based on the circuit integration technology may be used.

### INDUSTRIAL APPLICABILITY

An aspect of the present invention can be utilized, for example, in a communication system, communication equipment (for example, a cellular phone apparatus, a base station apparatus, a radio LAN apparatus, or a sensor device), an integrated circuit (for example, a communication chip), or a program.

### REFERENCE SIGNS LIST

10 Terminal apparatus
10A Main body unit
11 Controller
13L, 13R Display unit
14L, 14R Reproduction unit
15 Command input unit
16 Observation signal detection unit
17 Storage unit
18 Communication unit
19F Frame
19L, 19R Arm
26 Second observation signal detection unit
111 Function controller
112 Event detection unit
112A Line of sight detection unit
113 Visual information controller
114 Acoustic information controller
181 Reception unit
182 Transmission unit

1. A terminal apparatus comprising:
a display unit configured to display visual information that is visually recognized and superimposed on an external scene;
a detection unit configured to detect an event possibly causing danger by visually recognizing the visual information;
a mounting unit configured to be mountable on a head of a user and support the display unit and the detection unit; and
a controller configured to suppress display of the visual information on the display unit in a case that the event is detected.

2. The terminal apparatus according to claim 1,
wherein the detection unit is capable of detecting, as the event, that a moving distance of the detection unit is longer than a predetermined moving distance threshold.

3. The terminal apparatus according to claim 2,
wherein the detection unit is capable of detecting an amount of change in a rotating direction as the moving distance of the detection unit.

4. The terminal apparatus according to claim 2,
wherein the detection unit is capable of detecting the moving distance in a vertical direction as the moving distance of the detection unit.

5. The terminal apparatus according to claim 1,
wherein the detection unit detects approach of an object as the event.

6. The terminal apparatus according to claim 5,
wherein the detection unit determines a type of a sound source by using an acoustic signal acquired, and in a case that the type of the sound source determined is a traveling sound of a vehicle, detects the approach of the object based on a signal level of the acoustic signal.

7. The terminal apparatus according to claim 5,
wherein the terminal apparatus includes a signal transmission unit configured to transmit a transmission signal, and
the detection unit detects the object based on a level difference between a receive signal and the transmission signal or a time difference from transmission of the transmission signal to reception of the receive signal.

8. The terminal apparatus according to claim 1,
wherein the detection unit detects an entry into a predetermined area as the event.

9. The terminal apparatus according to claim 1,
wherein the detection unit detects a line of sight direction of the user, and
the controller suppresses display of the visual information within a predetermined range from the line of sight direction.

10. The terminal apparatus according to claim 1,
wherein the terminal apparatus includes a reproduction unit configured to reproduce acoustic information that is audible, and
the controller suppresses reproduction of the acoustic information in the reproduction unit in a case that the event is detected.

11. An operating method for a terminal apparatus comprising
a display unit configured to display visual information that is visually recognized and superimposed on an external scene,
a detection unit configured to detect an event possibly causing danger by visually recognizing the visual information, and
a mounting unit configured to be mountable on a head of a user and support the display unit and the detection unit, the operating method comprising the step of:
suppressing display of the visual information on the display unit in a case that the event is detected.

12. A program for a computer of a terminal apparatus comprising
a display unit configured to display visual information that is visually recognized and superimposed on an external scene,
a detection unit configured to detect an event possibly causing danger by visually recognizing the visual information; and
a mounting unit configured to be mountable on a head of a user and support the display unit and the detection unit, the program causing the computer to perform: suppressing display of the visual information on the display unit in a case that the event is detected.
